(19) United States
(12) Patent Application Publication
(10) Pub. No.: US 2017/0364214 A1
(43) Pub. Date: Dec. 21, 2017

(54) INTERACTIVE USER INTERFACE FOR MANAGING PROJECT ON-BOARDING AND GOVERNANCE COLLABORATIVELY

(71) Applicant: General Electric Company, Schenectady, NY (US)

(72) Inventors: Waqas JAVED, San Ramon, CA (US); Bo Yu, San Ramon, CA (US); Paulo R. PEREIRA, San Ramon, CA (US)

(21) Appl. No.: 15/186,786

(22) Filed: Jun. 20, 2016

(51) Int. Cl. G06F 3/0482; G06F 3/0484

(52) U.S. Cl. CPC G06F 3/0482; G06F 3/04845

(57) ABSTRACT

Provided are a system and methods for a user interface capable of managing projection overview information of a user. In one example, a method may include displaying a project overview screen including a plurality of project information objects each representing a category of project-related information of the user, receiving, from a user, a selection of a project information object from among the plurality of displayed project information objects, and in response to receiving the selection of the project information object from the user, expanding a size of a visual representation of the selected project information object on the project overview screen and with respect to the other project information objects, and revealing a plurality of subobjects within the expanded selected project information object, where the subobjects each represent a subcategory of the category of the project that is represented by the selected project information object.

### FIELD

Exemplary embodiments described herein relate generally to a user interface and, more particularly, to an interactive user interface that is capable of collecting textual information about collaborative projects, identifying responsible parties for governance and compliance of projects, and enabling users to easily keep track of project-related information

### BACKGROUND

Many questions posed to a user within an interface such as a web page require the user to select an answer from among multiple possible answers. When multiple options are available as a selection, designers will often use drop-down boxes or drop-down lists to provide a method to the user for choosing a selection from among multiple possible selections. A drop-down list is a type of graphical control element that is used by a graphical user interface (GUI) to provide consistent visual representations of information. When the drop-down list is inactive, it typically displays a single value or a previously selected value in a window or menu bar. When the list is activated, it drops down and displays a list of values from which the user may select from. When the user selects a value from the list, the drop-down list reverts back to its inactive state, displaying the selected value. A drop-down list can make it easier to display a large list of choices or options where initially a single choice is shown and the remaining choices may be shown by the user activating the drop-down feature of the drop-down list.

A drop-down list is often used in the design of graphical user interfaces, including web design. A designer can put a significant amount of information or possible selections in a form without cluttering the entire page, because the possible selections are hidden when not activated. However, a drop-down list has a number of drawbacks. For example, when a drop-down list becomes large enough it can be difficult for a user to conveniently scan or navigate through the list. Oftentimes a user will need to scroll inside the drop down list which can be a slow and painful experience. Furthermore, unless the cursor is positioned at a specific location on the page, a scroll command may cause the entire webpage to scroll instead of the drop-down list which can be frustrating and time consuming for the user. Another problem with drop-down lists is that they do not typically allow a user to make multiple selections within the list. That is, a drop-down list does not maintain awareness of the multiple selections but instead only remembers the most recent selection. Furthermore, the drop-down list does not provide a method for unselecting one or more previously selected items from the list. Furthermore, a vertical drop-down box may not adequately support application designs other than the traditional top to bottom flows.

### BRIEF DESCRIPTION OF THE DRAWINGS

Features and advantages of the exemplary embodiments, and the manner in which the same are accomplished, will become more readily apparent with reference to the following detailed description taken in conjunction with the accompanying drawings, in which:

FIG. 1 is a diagram illustrating an overview of a user interface for managing project information in accordance with an example embodiment.

FIG. 2 is a diagram illustrating a notification window of the user interface in accordance with an example embodiment.

FIG. 3 is a diagram illustrating a new project screen of the user interface in accordance with an example embodiment.

FIG. 4 is a diagram illustrating a project overview screen of the user interface in accordance with an example embodiment.

FIG. 5A is a diagram illustrating a business information screen generated by a selection from the project overview screen of FIG. 4, in accordance with an example embodiment.

FIG. 5B is a diagram illustrating a team information screen generated by a selection from the project overview screen of FIG. 4, in accordance with an example embodiment.

FIGS. 6A and 6B are diagrams illustrating a radial list associated with a team member information screen, in accordance with an example embodiment.

FIG. 7 is a diagram illustrating an architecture for supporting the user interface in accordance with an example embodiment.

FIG. 8 is a diagram illustrating a computing device for generating a user interface for managing project information in accordance with an example embodiment.

FIG. 9 is a diagram illustrating a method for generating a user interface for managing project information in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various exemplary embodiments. It should be appreciated that various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The exemplary embodiments described herein relate to a user interface for project information management. The term project as used herein is not meant to limit the scope of the exemplary embodiments and may refer to an activity, a task, a design, a job, a plan, an enterprise, a matter, a program, a proposal, a strategy, and the like. The user interface may provide an interactive user experience to better engage users in a collaborative environment while completing the information required for bringing their data into an infrastructure or other storage. Also provided is an underlying architecture to collect, store and extract project data information using a micro services layer in the domain of data governance and compliance. The architecture provides needed scalability for such a system along with effective exploration of the underlying data. The infrastructure may store and extract information about all the projects stored in the infrastructure. An example of some of the benefits provided by the embodiments herein include an interactive web-based user experience to provide, explore and track project information, a unique visual and interaction design to support seamless user interface, support for collaboration among different stakeholders involved in a project, a value-added service for information on-boarding and tracking in the infrastructure improving the overall user experience when exploring this data, and providing data governance and compliance for internal and external customer data.

The user interface described herein may be a web-based interface that makes use of a set of interactive widgets for enhancing a user experience through a game-like collaborative environment. The experience is designed to keep the user engaged in the process throughout. The user interface provides an innovative user experience from various views in the application including an overview experience and a project view experience. The user interface may provide a high level summary of all the requests previously created by a user, provide easy access to a timeline of updates about existing projects, provide awareness about any trouble (e.g. longer than expected approval time) with project approval, initiate a new project request or gather details on demand about an existing project, provide an overview of a project's status, provide an engaging way for the user to provide and keep track of the required information, and seamlessly integrate awareness about actions performed by other collaborators on the project.

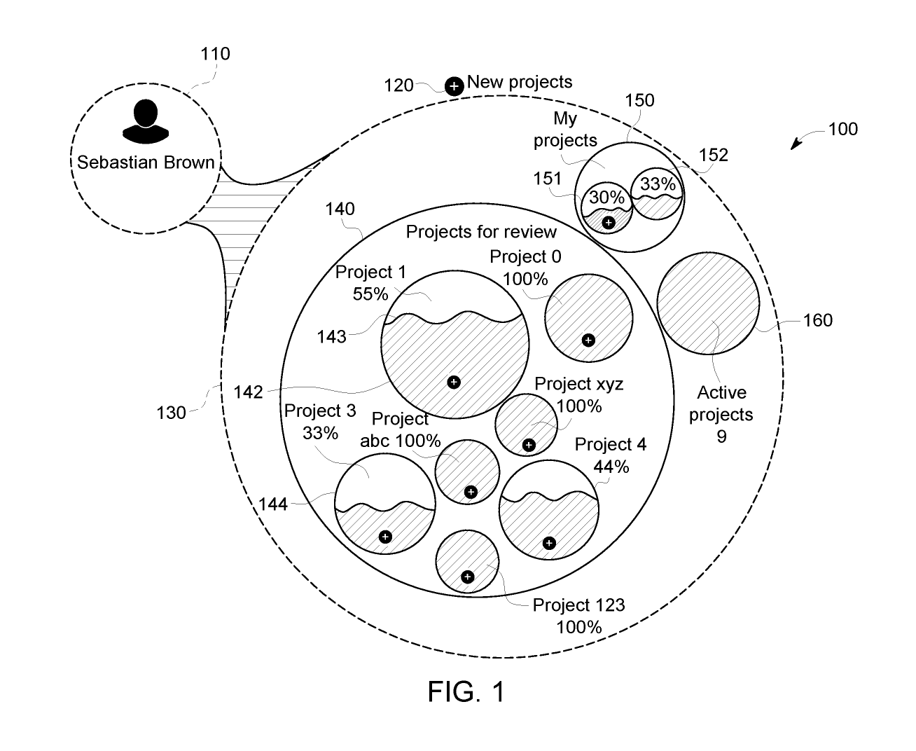

FIG. 1 is a diagram illustrating an overview of a user interface 100 for managing project information in accordance with an example embodiment. The user interface 100 may be displayed on a screen such as a computing screen, a touch screen, a multi-panel display, and the like. The screen may be included in, coupled to, or externally attached to a computing device such as a computer, a mobile device, a server, a tablet, a kiosk, and the like. An objective of the user interface 100 is to enable users to easily keep track of all of the projects they have initiated, projects for review, and active/archived projects for the user. Bubbles or other shaped objects may be used to categorize and organize different types of projects. Instead of using traditional methods to show this data using a tabular view, the exemplary embodiments make use of interactive circle packing in which each circle may represent a particular project, group of projects having a common attribute, and the like.

Referring to FIG. 1, the user interface 100 is displayed for a user 110. Here, the user interface 100 is provided in the form of a radial-based menu with objects (e.g., circles or bubbles) within that are used to represent selections that can be made by a user. The content that is displayed within the user interface 100 may be based on the user 110. For example, different information may be displayed based on whether the user 110 is a project creator, a project reviewer, a project lead, and the like. Identification of the user 110 may be performed when the user logs on to the user interface 100, and the like. The user interface 100 includes a create new project tab 120 that may be used to create a new project by the user 110. The user interface 100 also includes various objects which are used to hierarchically organize the data that is displayed to the user 110.

In this example, the outer object represents an overview object 130 of project information about the user 110 and includes a plurality of objects (e.g., three circles 140, 150, and 160) therein that represent project information objects which may be selected by the user. The project information objects may each represent a respective category of project related information about the user. In this example, the project information objects include a Project for Review object 140, a My Projects object 150, and an Active Projects object 160. In the example of FIG. 1, the Projects for Review object 140 (or bubble) has been selected by the user causing the user interface to expand a display of the Projects for Review object 140 and reveal various different projects for which the user 110 is designated as a reviewer. That is, by selecting a project information object from among a plurality of possible project information objects a user may drill down into various subcategories of the category corresponding to the project information object. It should be appreciated that the view a user is shown may be based on their role with the project, the company, and the like. Also, the details and the information provided by objects within the overview object 130 may vary based on the user type.

Here, the project information object represents the category Projects for Review, and the seven sub objects represent projects in which the user 110 is a reviewer. In this case, the seven sub objects are represented by seven bubbles and are included within a bubble of the Projects for Review object 140. In this example, a project completion status is represented using a fill level of an object. The fill level of an object may be a different color than a background color of the object. For example, subobject 142 has a bubble shape and represents Project 1. In addition, the subobject 142 has a fill level that occupies more than half of the bubble corresponding to subobject 142, which indicates that Project 1 is more than half (e.g., 55%) complete. In this example, the fill color is darker than the background color of the subobject 142 and is used to identify a level of the fill level. As another example, subobject 144 represents Project 0 and is completely filled, which indicates that Project 0 is complete. In addition, each object (e.g., bubble) may have a tab or other feature that may be selected by a user to further expand information included in the object. Furthermore, according to various aspects, a wave level or wave frequency included in the object at the top of the fill level may be used to represent whether a project is late, almost due, ahead of schedule, taking more time than expected, and the like. In Project 1 subobject, wave frequency 143 is rather choppy and indicates that Project 1 is taking longer than expected.

In addition to the Projects for Review object 140, the overview object 130 includes a My Projects object 150 and an Active Projects object 160 there within. According to various aspects, different fill colors and/or background may be used to represent whether a project has been turned in to a reviewer or whether a project is yet to be turned in. For example, in the My Projects object 150, subobject 151 represents a project that has not been turned in and subobject 152 represents a project that has been turned in. In this case, the subobject 151 has a fill color that is lighter in color than a fill color of the subobject 152, and is used to distinguish that the subobject 151 represents a project that has not been turned into a reviewer and the subobject 152 represents a project that has been turned into a reviewer.

In the example of FIG. 1, the color of an object indicates whether a project is submitted for review or not. Furthermore, a liquid fluid metaphor is used to further indicate the current state of the project. For example, the liquid fill level may represent the amount of progress for a project while the liquid wave frequency may represent whether the project is progressing as expected or whether there is trouble with the project. The various features of each project such as color, fill level, wave frequency, and the like, may be updated dynamically based on project progress and based on which user is looking at the screen. For example, a user who has been designated to review Project X, but who has not received Project X, may see a completion fill level indicating that 0% of the review of Project X has been completed. However, a user who is generating Project X, and who is halfway finished with Project X, but who has not turned Project X in, may see a fill level indicating that 50% of Project X has been completed and have a color indicating Project X has not been turned in.

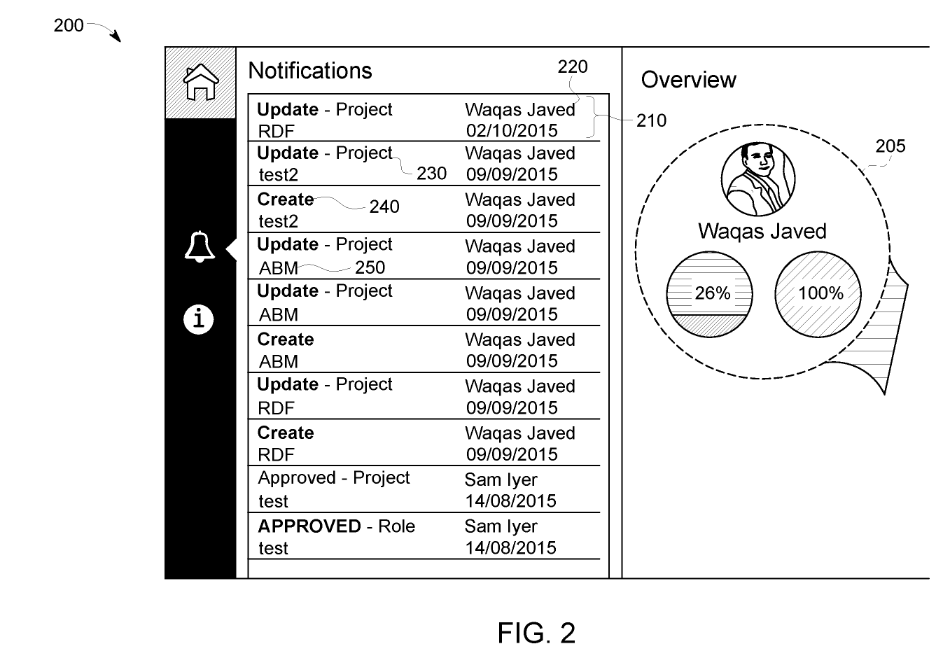

FIG. 2 illustrates a notification window 200 of the user interface in accordance with an example embodiment. Through the notification window 200, users may quickly see and recognize a timeline of notifications generated as a result of being a project creator or being added by the action of other collaborators. The notifications may be captured and pushed to the interface in real time. Users may also expand the details about a notification by hovering over it with a cursor and may select a project by clicking it. Referring to FIG. 2, the notification window is based on project information corresponding to user 205. In this example, the notification window 200 includes a plurality of notifications 210. Each notification 210 includes a creator 220, a type 230, an action or result 240, and a title 250. For example, the creator 220 may be the user or it may be a collaborator of the user. The type 230 may be a project, a role in the project, and the like. An action or result 240 may be an update action, a create action, a rejection result, an approval result, and the like.

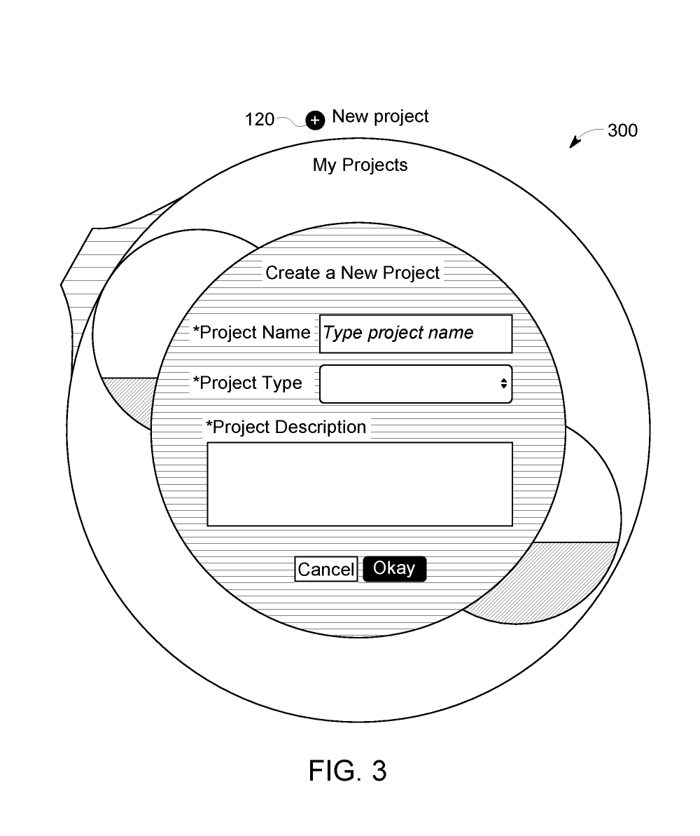

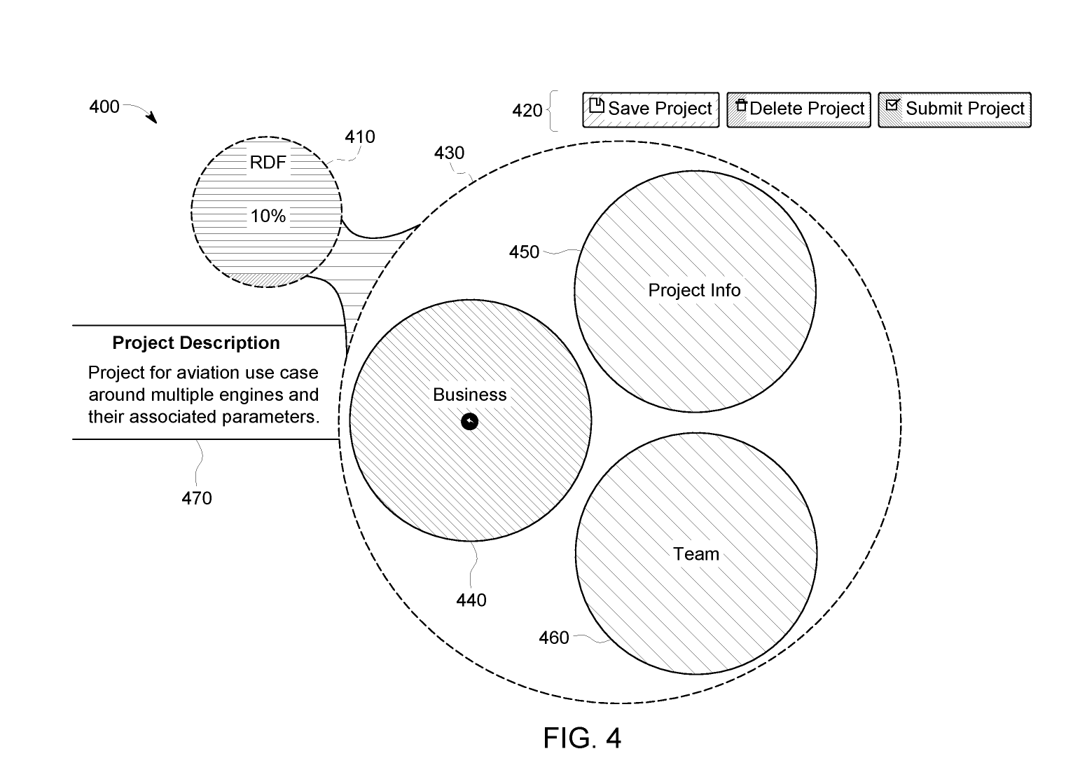

FIG. 3 is a diagram illustrating a new project screen 300 of the user interface in accordance with an example embodiment. The new project screen 300 may be generated in response to a user selecting the new project tab 120 shown in FIG. 1. In response to selecting to generate a new project, various project-related information may be requested through input fields such as Project Name, Project Type, Project Description, and the like. The user may generate the new project through a selection such as selecting a submit button, an OK button, and the like. When the new project is generated, the new project screen 300 may close and project overview screen 400 of the user interface may be displayed as shown in the example of FIG. 4.

Referring to FIG. 4, a project object 410 (e.g., circle or bubble) represents a new project and includes the name of the project which in this case is ‘RDF.’ The project object 410 may also include a fill level indicating a progress status of the project and a color indicating whether the project has been turned in. In the example of FIG. 4, the project object 410 has a corresponding project view object 430 that includes a plurality of objects there within that may be selected by the user and used to input various information about the project. In some cases, the objects within the project view object 430 may be the same for each project or they may be different based on, for example, a type of project, a project description, and the like. For example, the user interface may extract information from at least one of the project type field or the project description field shown in FIG. 3, and generate various objects within the overview object 430 based thereon. Located above the project overview object 430 are action tabs 420 that allow the user to save a project, delete a project, submit a project, and the like.

In this example, the project view object 430 includes a business information object 440, a project information object 450, and a team member information object 460. A user may select any of the default objects to enter information about the project. In addition, the user may take action with the project by selecting an action tab from the project action bar 410 in order to perform various actions with respect to the project such as save the project, delete the project, and submit the project for review. Also shown in FIG. 4 is a project description 470 which may be entered by the user from the new project screen 300 shown in FIG. 3.

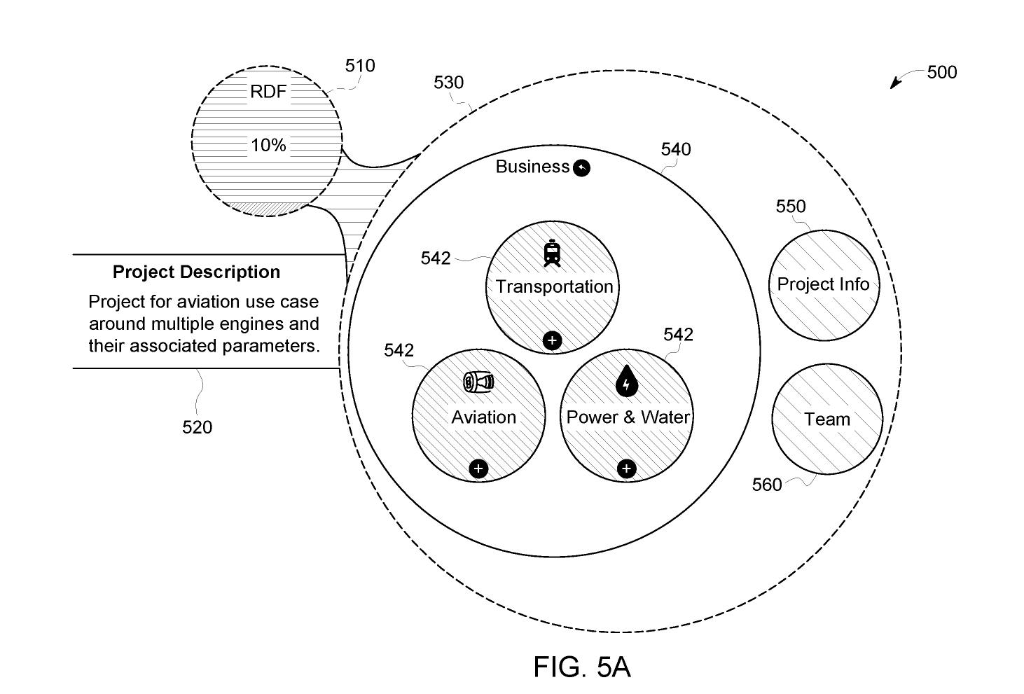

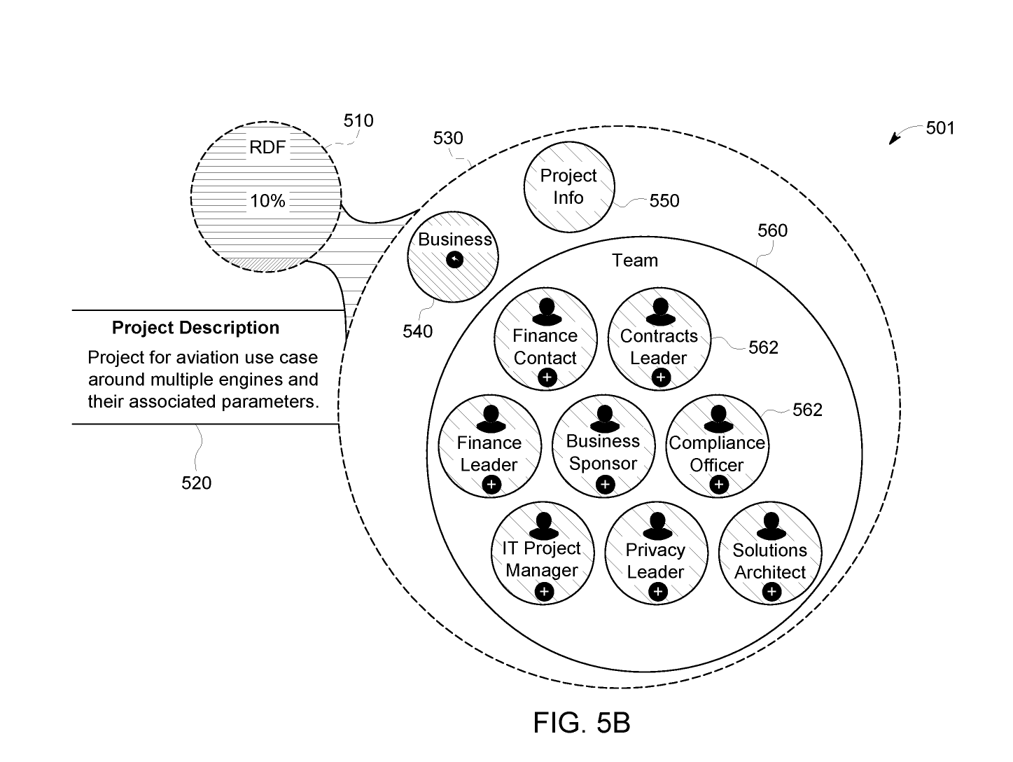

FIG. 5A illustrates a business information screen 500 generated by a selection of the business bubble from the project overview screen of FIG. 4, in accordance with an example embodiment. Referring to FIG. 5A, the business overview screen 500 has a project object 510 including the name of the project and an indication of the completion status and a turned-in status of the project. The project object 510 has a corresponding project view object 530 that includes a plurality of objects (business information object 540, a project information object 550, and a team member information object 560) which may be selected by the user and used to input various information about the project. The plurality of objects revealed or displayed within the project view bubble 530 may vary based on one or more of the project description and the project type entered by the user about the project. That is, the objects that are revealed and which may receive user input may change based on the project description entered by the user during the project creation phase. As another example, all projects may have the same objects (e.g., default bubbles) displayed regardless.

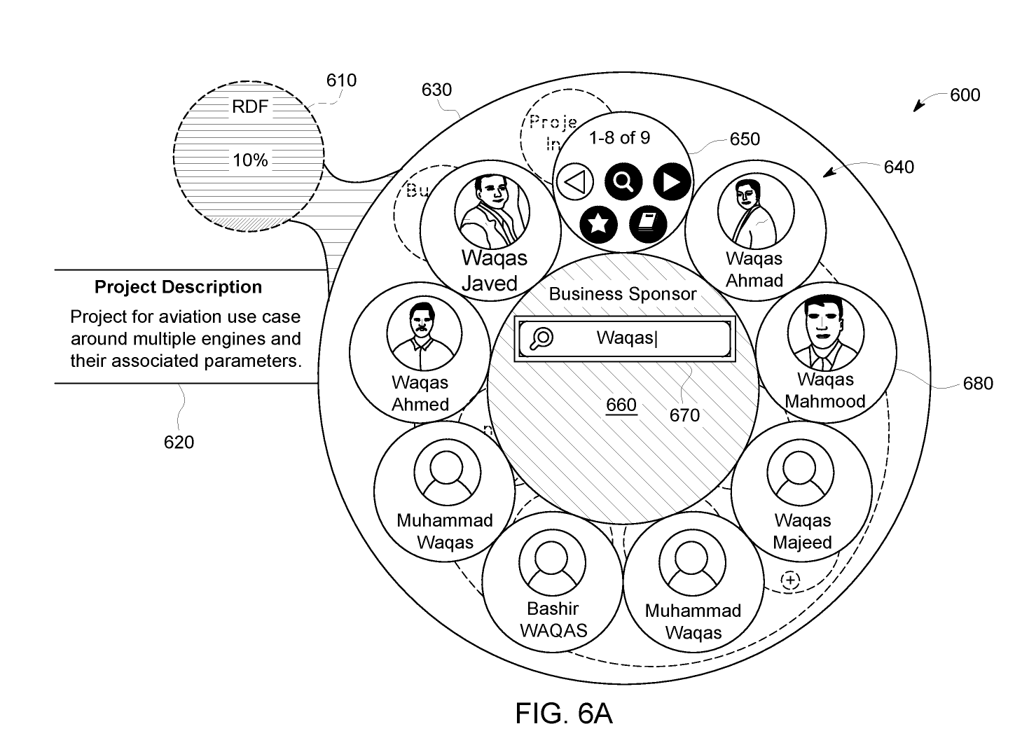

In this example, a user has selected the business information object 540 (shown in FIG. 4 as 440). In response, the business information object 540 expands in a circular fashion and reveals the possible options available for selection under the business information object 540 which in this case includes subobjects 542 (i.e., transportation, aviation, and power and water bubble) representing different possible business areas of the project 510. By revealing the selections in a radial or circular fashion, the user is able to simultaneously view all options for inputting business information about the project 510. Furthermore, although not shown in FIG. 5, if the user were to select one of the subobjects 542, the sub object would further expand in a circular fashion to reveal selections possible within. In this example, when the user selects the business information object 540, the other objects (e.g., the project information object 550 and the team member information object 560) move outward within the project view object 530 to make room for the expanding of the business information object 540. In some cases, project view object 530 may expand to provide additional room to display the object included within in response to an object or sub object being selected. As another example, if the user interface screen runs out of room for displaying options within a selected object, a selected object may be expanded into a screen that overlays a previous screen, an example of which is described in FIG. 6.

FIG. 5B illustrates a team member information screen 501 generated by a selection from the project overview screen of FIG. 4, in accordance with an example embodiment. Referring to FIG. 5B, the team information screen 501 is similar to the business information screen 500 shown in FIG. 5A, except in this case the team member information object 560 is selected by the user (shown in FIG. 4 as 460). In response to being selected, the team member information object 560 expands in a circular fashion to reveal the possible selections available under the team member information object 560, which in this case includes sub-objects 562 representing different roles and different people associated with the project 510. By revealing the selections in a radial or circular fashion, the user is able to simultaneously view all options for inputting team member information about the project 510. In the examples of FIGS. 5A and 5B, a project-related object corresponding to a category is selected and then a plurality of sub project-related objects representing sub-categories of the respective category are revealed. In this way, a user may hierarchically drill down within objects until a user reaches an end of the project related information.

FIGS. 6A and 6B illustrate a radial list view 600 that is associated with the team member information screen 501 of FIG. 5B, in accordance with an example embodiment. Referring to FIG. 6A, a selection of a team member object 562 shown in FIG. 5B is selected, and in response, the user interface displays a radial list 640 on top of (i.e., as an overlay) the displayed team member information screen 501. In addition, the project view object 630 (shown as 530 in FIG. 5B) has a background color that is changed (e.g., grayed out) and the radial list 640 is displayed on top of the project view object 630. In this example, possible selections such as 680 from the radial list 640 are displayed about a central object 660 which includes a search bar 670. The user may enter a name, or other identifying information about a person into the search bar 660 and the possible matches or possible selections 680 may be displayed as bubbles as shown in the radial list 640 about the central object 660. The radial list 640 also includes a navigation object 650 which allows the user to perform various actions with respect to the radial list 640. For example, the radial list 640 may display a predetermined amount of matches (which in this example is eight matches). In a situation in which nine possible matches are returned, in this example, the first eight matches may be displayed and the user may select a command on the navigation bubble 650 to move or spin the radial list 640 about the central bubble 660 such that the ninth match is displayed in place of one of the previous eight matches.

According to various exemplary embodiments, problems associated with a drop-down list are solved by the radial list 640 which may improve the user experience when selecting multiple items from the radial list 640. Here, the innovative radial list 640 may integrate and work seamlessly with an underlying circular design of different widgets of a webpage or other graphical interface. In the example of FIGS. 6A and 6B, a user is using the radial list 640 to identify a business sponsor for project 610, however, the examples are not limited thereto. For example, the radial list may display business information, project information, information about different project roles, and the like. Referring to FIG. 6B, the user may make a selection from the radial list 640 and the selected item 690 may be highlighted by color change and also visualized inside the inner circular container (i.e., the central object 660) at the center of the widget. For example, the user may select a bubble from the radial list 640 by clicking on it or dragging it inside the central object 660. As multiple items are selected, the selected items may all remain visible to the user even if they move to another location in the list or search for another item. Accordingly, the user can easily unselect an item by clicking on it or dragging it out of the central object 660. For example, the user may unselect previously selected selection 690 by clicking on it or by dragging and dropping the item outside of the central object 660.

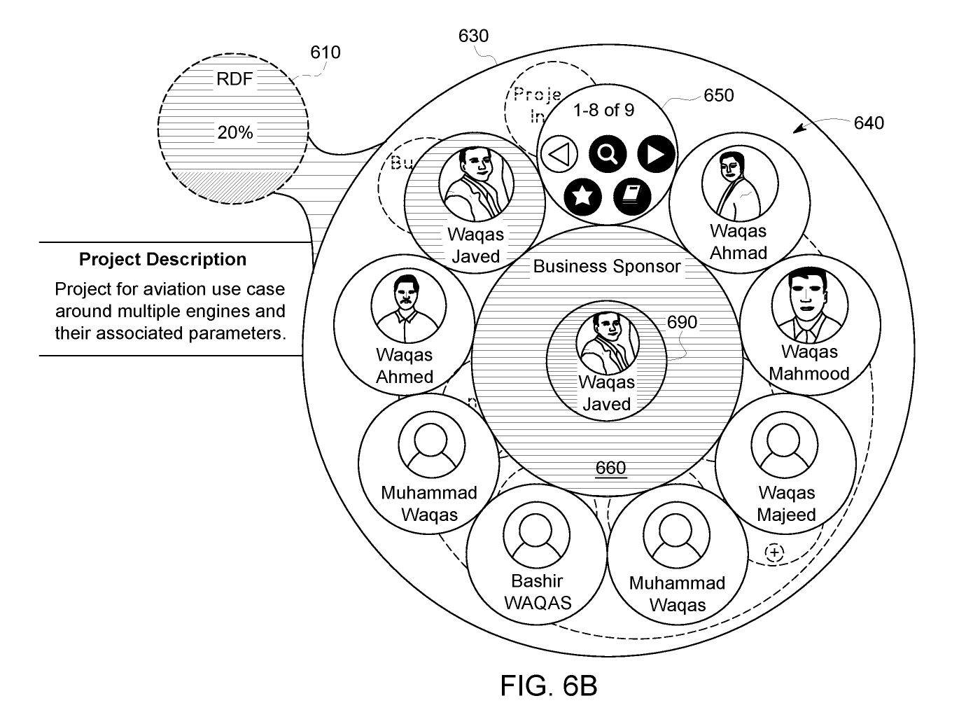

FIG. 7 illustrates an architecture 700 for supporting the user interface in accordance with an example embodiment. The architecture 700 highlights different building blocks that may be used in a system for generating the user interface described herein. Provided in this example are functionalities of different architectural modules. For example, a database layer 710 represents data used to generate the user interface. Because of the connected nature of application data, the information for the user interface may be stored in a graph structure. For example, the database layer 710 may include a graph blue print and may provide access to data efficiently on demand. According to various exemplary embodiments, the architecture includes a micro services layer 720 which is used to achieve better robustness, application flexibility and dynamic user experience. FIG. 7 highlights different micro services that may be supported by the system and it should be appreciated that additional micro services may be used to support evolving system needs. The architecture 700 also includes a client side layer 730 including an interactive web-based application that allows users to provide, review, approve and revisit the underlying information. In this example, a client side application may use representational state transfer (REST) application programming interfaces (APIs) to connect, send and pull data through different underlying micro services. Individual micro services may support one or more features supported in the client side application. Also, to achieve robustness, flexibility and speed microservices may be distributed and replicated in backend cloud infrastructure (e.g., cloud foundry).

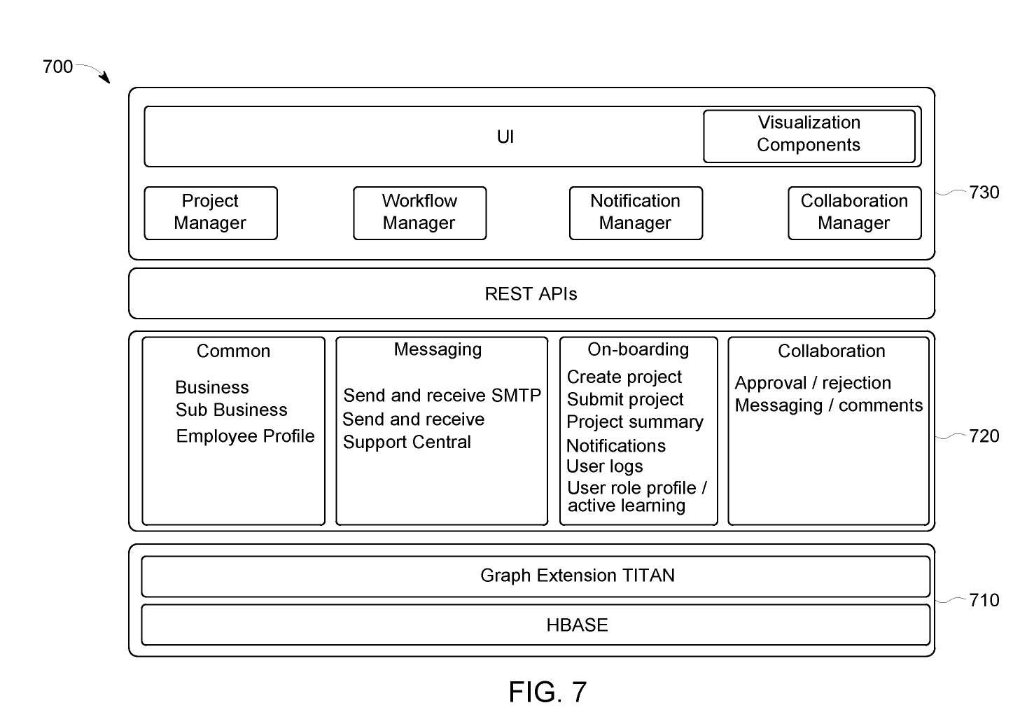

FIG. 8 illustrates a computing device 800 for generating a user interface for managing project information in accordance with an example embodiment. For example, the computing device 800 may be a workstation, a computer, a laptop, a mobile phone, a tablet, a kiosk, and the like. Referring to FIG. 8, the computing device 800 includes a network interface 810, a processor 820, a display 830, and a storage 840. Although not shown in FIG. 8, the computing device 800 may include other features, for example, a transmitter, a receiver, and the like. The network interface 810 may transmit and receive data over a network such as the Internet. The processor 820 may include a single core processing device, a multicore processing device, or multiple processing devices. The processor 820 may control the overall operations of the computing device 800. The display 830 may be an embedded display such as a touch screen on a mobile device or it may be an external display attached to the computing device through a connection such as a wired or wireless connection, and may display a user interface described according to various example embodiments. The storage 840 may include any desired device, for example, random access memory (RAM), one or more hard disks, cache, hybrid memory, an external memory, flash memory, and the like. The input unit 850 may include one or more of a keyboard, a mouse, a touchscreen, a touchpad, a camera, a microphone, and the like.

The display 840 may display a user interface and any of the examples previously described with respect to FIGS. 1-6B. For example, the display 840 may display a project overview screen of the user interface. The project overview screen may include a plurality of project information objects each representing a category of project-related information of the user of the user interface. The input unit 850 may receive, from the user, a selection of a project information object from among the plurality of displayed project information objects being displayed on the project overview screen. In this example, the project overview screen may be displayed on the display 840 having an outline of an object such as a circle or a bubble and the plurality of project information objects may be displayed within the outlie of the project overview screen object and may be represented by similar object shapes such as circles or bubbles on the display 840.

In response to the input unit 850 receiving the selection of the project information object from the user, the processor 820 may expand a size of a visual representation of the selected project information object on the project overview screen and with respect to the other project information objects. For example, the processor 820 may expand the size of a circle representing the selected project information object within the project overview screen. Also, the processor 820 may reveal a plurality of subobjects within the expanded selected project information object. In this example, the subobjects may each represent a subcategory of the category of the project that is represented by the selected project information object. In these examples, the plurality of subobjects may each have a same shape as a shape of the plurality of project information objects. In some examples, the processor 820 may move a position of the other project information objects within the project overview screen to make room for the expanded size of the display of the selected project information object. In addition to displaying the objects and subobjects, the processor 820 may display a liquid fill level in each of the objects and/or subobjects indicating a completion status of a project related activity represented by each of the objects/subobjects.

In some examples, the input unit 850 may further receive a selection of a subobject from the user. In response to receiving the selection of the subobject, the processor 820 may display a radial list comprising possible selections for the user to choose from for a subcategory of the project represented by the subobject. For example, the possible selections of the radial list may each be represented by selectable objects within the radial list, and the selectable objects may be arranged about a central object of the radial list. The radial list may include a navigation object which allows the user to navigate through the radial list of possible selections.

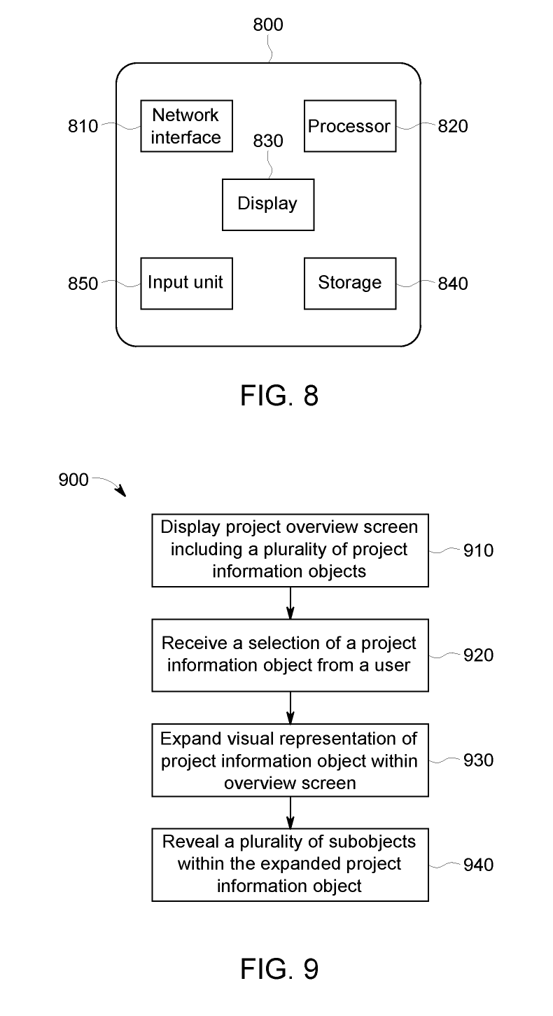

FIG. 9 illustrates a method 900 of a user interface for managing project information in accordance with an example embodiment. Referring to FIG. 9, the method 900 may include displaying a project overview screen on a display device, in 910, where the project overview screen includes a plurality of project information objects each representing a category of project-related information of the user. The method 900 may further include receiving, from the user, a selection of a project information object from among the plurality of displayed project information objects, in 920. In response to receiving the selection of the project information object from the user, the method 900 may further include expanding a size of a visual representation of the selected project information object on the project overview screen and with respect to the other project information objects, in 930, and revealing a plurality of subobjects within the expanded selected project information object, in 940. In this example, the subobjects may each represent a subcategory of the category of the project that is represented by the selected project information object.

The example embodiments are related to data storage devices as well as tools, processes, and an innovative user interface design to govern, track and facilitate data ingestion into the data storage. For example, the data storage may include one or more of a back-end server, a cloud storage, a data lake, a server, and the like. In the data lake example, the data storage infrastructure may host ‘big data’ from several business entities. One of the important features towards the success of such an infrastructure is the capability to effectively collect contextual information about the underlying data and to identify responsible parties for data governance and compliance. However, traditionally this process was not standardized and prior methods lack the process integration required to achieve this effectively. The example embodiments may provide the tools, processes and an interactive user interface that is able to collect the meta-information around governance, compliance and usage of the data being ingested into data-lake.

In some of the examples provided, a flexible backend infrastructure is built on top of micro services architecture and graph database to collect, store and track the meta-information about underlying data. The end user application (e.g., user interface) may include a web-based interface that makes use of a set of novel interactive widgets to enhance user experience through a game like collaborative environment. The user experience may keep the user engagement level high throughout a process that can otherwise be overwhelming and boring for the user, as previous applications often required users to answer a number of contextual questions about their data. Furthermore, the exemplary embodiments facilitate the collaboration among multiple stakeholders who need to review, approve and amend information provided by a project lead or other users.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method of a user interface for managing project-related information of a user, the method comprising:
displaying a project overview screen on a display device, the project overview screen comprising a plurality of project information objects each representing a category of project-related information of the user;
receiving, from the user, a selection of a project information object from among the plurality of displayed project information objects; and
in response to receiving the selection of the project information object from the user, expanding a size of a visual representation of the selected project information object on the project overview screen and with respect to the other project information objects, and revealing a plurality of subobjects within the expanded selected project information object, wherein the subobjects each represent a subcategory of the category of the project that is represented by the selected project information object.

2. The method of claim 1, wherein the plurality of subobjects each comprise a same shape as a shape of the plurality of project information objects.

3. The method of claim 1, further comprising moving a position of the other project information objects within the project overview screen to make room for the expanded size of the display of the selected project information object.

4. The method of claim 1, further comprising receiving a selection of a subobject from the user, and in response to receiving the selection of the subobject, displaying a radial list comprising possible selections for the user to choose from for a subcategory of the project represented by the subobject.

5. The method of claim 4, wherein the possible selections of the radial list are each represented by selectable objects within the radial list, and the selectable objects are arranged about a central object of the radial list.

6. The method of claim 4, wherein the radial list further comprises a navigation object included within the radial list and which allows the user to navigate through the radial list of possible selections.

7. The method of claim 1, further comprising displaying a liquid fill level in each of the subobjects indicating a completion status of a project related activity represented by each of the subobjects.

8. A computing device for generating a user interface for managing project-related information of a user, the computing device comprising:
a display device configured to display a project overview screen of the user interface, the project overview screen comprising a plurality of project information objects each representing a category of project-related information of the user;
an input unit configured to receive, from the user, a selection of a project information object from among the plurality of displayed project information objects being displayed; and
a processor configured to, in response to receiving the selection of the project information object from the user, expand a size of a visual representation of the selected project information object on the project overview screen and with respect to the other project information objects, and reveal a plurality of subobjects within the expanded selected project information object, wherein the subobjects each represent a subcategory of the category of the project that is represented by the selected project information object.

9. The computing device of claim 8, wherein the plurality of subobjects each comprise a same shape as a shape of the plurality of project information objects.

10. The computing device of claim 8, wherein the processor is further configured to move a position of the other project information objects within the project overview screen to make room for the expanded size of the display of the selected project information object.

11. The computing device of claim 8, wherein the input unit is further configured to receive a selection of a subobject from the user, and in response to receiving the selection of the subobject, the processor is further configured to display a radial list comprising possible selections for the user to choose from for a subcategory of the project represented by the subobject.

12. The computing device of claim 11, wherein the possible selections of the radial list are each represented by selectable objects within the radial list, and the selectable objects are arranged about a central object of the radial list.

13. The computing device of claim 11, wherein the radial list further comprises a navigation object included within the radial list and which allows the user to navigate through the radial list of possible selections.

14. The computing device of claim 8, wherein the processor is further configured to display a liquid fill level in each of the subobjects indicating a completion status of a project related activity represented by each of the subobjects.

15. A non-transitory computer readable medium having stored therein instructions that when executed cause a computer to perform a method of a user interface for managing project-related information of a user, the method comprising:
displaying a project overview screen on a display device, the project overview screen comprising a plurality of project information objects each representing a category of project-related information of the user;
receiving, from the user, a selection of a project information object from among the plurality of displayed project information objects; and
in response to receiving the selection of the project information object from the user, expanding a size of a visual representation of the selected project information object on the project overview screen and with respect to the other project information objects, and revealing a plurality of subobjects within the expanded selected project information object, wherein the subobjects each represent a subcategory of the category of the project that is represented by the selected project information object.

16. The non-transitory computer readable medium of claim 15, wherein the plurality of subobjects each comprise a same shape as a shape of the plurality of project information objects.

17. The non-transitory computer readable medium of claim 15, wherein the method further comprises receiving a selection of a subobject from the user, and in response to receiving the selection of the subobject, displaying a radial list comprising possible selections for the user to choose from for a subcategory of the project represented by the subobject.

18. The non-transitory computer readable medium of claim 17, wherein the possible selections of the radial list are each represented by selectable objects within the radial list, and the selectable objects are arranged about a central object of the radial list.

19. The non-transitory computer readable medium of claim 17, wherein the radial list further comprises a navigation object included within the radial list and which allows the user to navigate through the radial list of possible selections.

20. The non-transitory computer readable medium of claim 15, wherein the method further comprises displaying a liquid fill level in each of the subobjects indicating a completion status of a project related activity represented by each of the subobjects.
